(19) United States
(12) Patent Application Publication
(10) Pub. No.: US 2013/0299593 A1
(43) Pub. Date: Nov. 14, 2013

(54) PARALLEL STAGE POWER OUTPUT RECTIFIER FOR RADIO-FREQUENCY IDENTIFICATION (RFID) DEVICES, AND RELATED COMPONENTS AND METHODS

(71) Applicant: Robert Mason Glidden III, Rancho Palos Verdes, CA (US)

(72) Inventor: Robert Mason Glidden III, Rancho Palos Verdes, CA (US)

(21) Appl. No.: 13/470,549

(22) Filed: May 14, 2012

(51) Int. Cl. G06K 19/073; H02M 7/06; H02M 7/217

(52) U.S. Cl. 235/492; 363/125; 363/126

(57) ABSTRACT

Parallel stage power output rectifiers for radio-frequency identification (RFID) devices and related components and methods are disclosed. An RFID tag receives a radio-frequency (RF) signal comprising RF input energy through an input such as an antenna. The RF input energy provided to a rectifier splits the RF input energy into two or more stages having parallel electrical outputs. The parallel electrical outputs allow for a more efficient use of the input energy in terms of current draw and improves voltage droop, thus improving the range and operation of the RFID tag.

### BACKGROUND

1. Field of the Disclosure

The technology of the disclosure relates to radio-frequency identification (RFID) tags and rectifiers therein.

2. Technical Background

It is well known to employ radio-frequency (RF) identification (RFID) transponders to identify articles of manufacture. RFID transponders are often referred to as “RFID tags.” RFID tags are comprised of an integrated circuit (IC) that is coupled to an antenna. An identification number or other characteristic is stored in the IC or in memory coupled to the IC, which can be provided to another system, such as an RFID reader, to provide identification information for a variety of purposes. For example, if the RFID tag is an active device, the RFID tag includes a transmitter that can transmit the identification to another system. If the RFID tag is a passive or semi-passive device, the RFID tag does not include a transmitter. The passive or semi-passive RFID tag includes a receiver that includes an antenna that receives a wireless RF signal from a transmitter, also known as an interrogation signal. The passive or semi-passive RFID tag responds to receipt of the interrogation signal such as by providing identification information, via backscatter modulation communications.

Passive RFID tags rely on the energy incident on the antenna to provide power to the components within the RFID tag. The passive RFID tags include a power rectifier that takes the time varying electromagnetic signal incident on the antenna and converts the time varying signal into a direct current power supply for use by the components within the RFID tag. The power rectifier includes a number of series connected charge pump stages where the output of a first stage is serially provided to an input of a second stage, and a single cumulative power output from the final stage is provided for use by components with the RFID tag. While the output voltage of the series connected charge pump stages is cumulative, the cumulative voltage is not additively linear due to bias conditions in each stage. Communications robustness, generally associated with the operating range as the key metric, comes from improving efficiency of the rectifier. Conventional rectifier efficiencies may be approximately twenty percent, so there remains room for improvement in rectifier efficiencies.

An RFID tag requires a basic minimum current to operate, and it is necessary to provide this minimum current at a minimum required voltage as well. However, as more current is drawn from the rectifier, the more the voltage of the rectifier droops; circuit operation could be limited by either. Improving performance relies on achieving best power (voltage×current) efficiency, allowing for extended range and greater resilience to variable RF energy propagation conditions. Design optimization for maximum efficiency strives to achieve simultaneous limitation of minimum voltage and minimum current for a given load circuit; to the extent output voltage and current are not simultaneously limiting, input energy requirements are higher than they need be, translating to waste.

### SUMMARY OF THE DETAILED DESCRIPTION

Embodiments disclosed herein include a parallel stage power output rectifier for Radio-frequency Identification (RFID) devices. Related components and methods are also disclosed herein. In an exemplary embodiment, an RFID tag receives a radio-frequency (RF) signal comprising RF input energy through an input such as antenna. The RF input energy is provided to a rectifier that splits the RF input energy into two or more stages having parallel electrical outputs. The parallel electrical outputs allow for a more efficient use of the input energy in terms of current draw and improves voltage droop, thus improving the range and operation of the RFID tag.

In this regard, in one embodiment, an RFID tag is provided. The tag comprises a partition comprising an input configured to connect to an RF antenna to receive an RF signal comprising RF input energy and a rectifier configured to split the RF input energy. The rectifier comprises a first charge pump stage configured to receive at least a portion of the RF input energy from the input and provide a first power output. The rectifier also comprises a second charge pump stage configured to receive at least a portion of the RF input energy from the input and provide a second power output electrically parallel to the first power output.

In another embodiment, a RFID rectifier configured to split input radio-frequency (RF) energy into multiple power stages is provided. In an exemplary embodiment, the rectifier comprises a first charge pump stage configured to receive RF input energy from an antenna and provide a first power output. The rectifier also comprises a second charge pump stage configured to receive the RF input energy from the antenna and provide a second power output electrically parallel to the first output.

In another embodiment, a method for splitting input radio-frequency (RF) energy into multiple power stages is provided. In an exemplary embodiment the method comprises receiving at a first charge pump stage in a rectifier RF input energy from an antenna and providing a first power output from the first charge pump stage. The method also comprises receiving at a second charge pump stage in the rectifier RF input energy from the antenna and providing a second power output from the second charge pump stage, wherein the second power output is electrically parallel to the first power output.

As non-limiting examples, the parallel electrical outputs are provided to different partitions within the RFID tag. The parallel outputs allow for more flexibility in designing the rectifier because a single strand of serially connected charge pump stages no longer has to provide all the voltage and current for the RFID tag. By providing the loads in parallel, the voltage and current loads are optimized for more efficient use of the incident input energy.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a schematic block diagram of an exemplary radio-frequency identification (RFID) tag;

FIG. 2 is a schematic block diagram of an exemplary parallel stage rectifier for use in an RFID tag;

FIG. 3 is a schematic diagram of a conventional exemplary charge pump stage using diodes;

FIG. 4 is a schematic diagram of a conventional exemplary charge pump stage using field effect transistors;

FIG. 5 is a schematic block diagram of an exemplary conventional series stage rectifier;

FIG. 6 is an exemplary conventional load current versus output voltage graph for the exemplary series stage rectifier of FIG. 5;

FIG. 7 is an exemplary load current versus output voltage graph for the exemplary parallel stage rectifier of FIG. 2;

FIG. 8 is a schematic block diagram of an exemplary alternate embodiment with mixed series-parallel stages;

FIG. 9 is a schematic block diagram of an exemplary alternate embodiment with an intermediate power output;

FIG. 10 is a schematic block diagram of an exemplary alternate embodiment with two intermediate power outputs;

FIG. 11 is a schematic block diagram of an exemplary alternate embodiment having a power storage element; and

FIG. 12 is an exemplary load current versus output voltage graph for the embodiment of FIG. 11.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed herein include a parallel stage power output rectifier for Radio-frequency Identification (RFID) devices. Related components and methods are also disclosed here. In an exemplary embodiment, an RFID tag receives a radio-frequency (RF) signal comprising RF input energy through an input such as antenna. The RF input energy is provided to a rectifier that splits the RF input energy into two or more stages having parallel electrical outputs. The parallel electrical outputs allow for a more efficient use of the input energy in terms of current draw and improves voltage droop, thus improving the range and operation of the RFID tag.

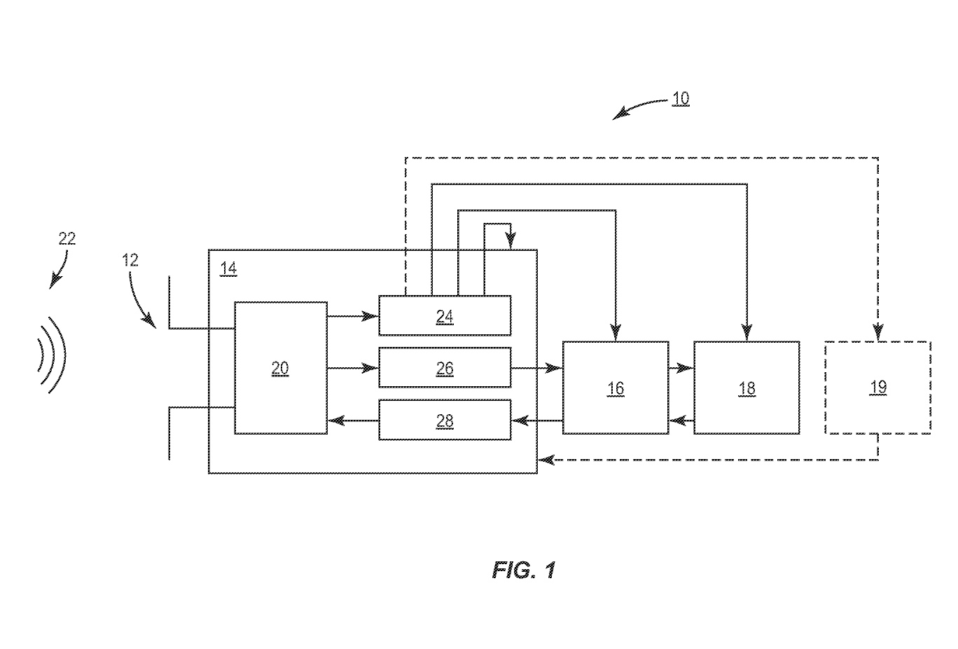

In this regard, FIG. 1 illustrates an exemplary RFID tag 10 that may incorporate exemplary embodiments of the present disclosure. Specifically, the RFID tag 10 may include an RF antenna 12, an analog partition 14, a digital partition 16, and a memory partition 18. In an exemplary embodiment, a power storage partition 19 may be present. In other alternate embodiments, the power storage element may be in a different partition (e.g., analog partition 14, digital partition 16, or memory partition 18) as desired or practical. In an exemplary embodiment, the analog partition 14 includes an antenna port 20, which acts as an input configured to connect to the RF antenna 12 and receive an RF signal 22 having RF input energy as is understood. The analog partition 14 further includes a rectifier 24, a demodulator 26, and a modulator 28. The demodulator 26 and modulator 28 are conventional and understood by those of ordinary skill in the art. The rectifier 24 is explained in greater detail below. While not shown, the analog partition 14 may include a regulator coupled to the rectifier 24, an oscillator, and other analog components without departing from the scope of the present disclosure.

With continuing reference to FIG. 1, the digital partition 16 may include a command decoder module, a command execution module, state machine modules, clocks and timing modules, a memory interface and other digital components (none illustrated) as is conventional. The digital partition 16 uses power from the rectifier 24 to allow operation of the components within the digital partition 16. Similarly, the digital partition 16 accesses the memory partition 18 through conventional techniques. The memory partition 18 may include a controller and bit array as is conventional, with corresponding column drives, row decoders, and other memory components as is understood. The memory partition 18 also uses power from the rectifier 24.

With continuing reference to FIG. 1, the power storage partition 19 may contain a capacitor (not shown in FIG. 1) that provides power to flash a light emitting diode (LED, also not shown) or other element which may require power at a time when the RFID tag 10 is not being interrogated and as such does not have RF signal 22 from which to provide power. In this case, the rectifier 24 charges the capacitor over time until the capacitor reaches the maximum voltage that can be supplied by the rectifier 24. Then, when it is appropriate to cause the LED to flash, the capacitor is discharged through the LED, and the LED illuminates for a short period of time or illuminates in a set of short flashes. As an aside, the voltage required for such power storage may be different (e.g., higher) than the voltage required for other partitions within the RFID tag 10.

In operation, the analog partition 14 acts on an incoming RF signal 22 in two ways. First, the information content of the RF signal 22 is interpreted by the demodulator 26 while energy needed for all tag functions is derived from the rectifier 24. The rectifier 24 provides direct current for use by the partitions 14, 16, and 18. Given the nature of typical incoming RF signals 22, the incident power is usually measured in microwatts, and the corresponding voltages and currents produced by the rectifier 24 are similarly small. In an exemplary embodiment, the analog partition 14 may require approximately 1 V to operate, the digital partition 16 may require approximately 700 mV to operate, and the memory partition 18 may require around 1.5 V to operate. The power storage partition 19 may require more than 2 V (e.g., ˜1.8 V for a red LED, ˜2.4 V for an amber LED, ˜3.6 V for a blue LED) to operate. It is worth noting that typically all the analog components need about the same voltage levels, similarly, all the digital components need about the same voltage level. Thus, it is possible to think of the partitions by power supply voltage level requirements instead of analog, digital, or the like. However, because related circuit topologies (analog, digital, etc.) each need about the same supply voltage, it is likely that any partition will fall loosely within the analog, digital, memory, power storage partitions set forth herein.

An RFID tag requires a basic minimum current to operate, and it is necessary to provide this minimum current at a minimum required voltage as well. However, as more current is drawn from the rectifier, the more the voltage of the rectifier droops; circuit operation could be limited by either. Improving performance relies on achieving best power (voltage×current) efficiency, allowing for extended range and greater resilience to variable RF energy propagation conditions. Design optimization for maximum efficiency strives to achieve simultaneous limitation of minimum voltage and minimum current for a given load circuit; to the extent output voltage and current are not simultaneously limiting, input energy requirements are higher than they need be, translating to waste.

In this regard, embodiments disclosed herein include a parallel stage power output rectifier for Radio-frequency Identification (RFID) devices. In an exemplary embodiment, an RFID tag receives a radio-frequency (RF) signal comprising RF input energy through an input such as antenna. The RF input energy is provided to a rectifier that splits the RF input energy into two or more stages having parallel electrical outputs. The parallel electrical outputs allow for a more efficient use of the input energy in terms of current draw and improves voltage droop, thus improving the range and operation of the RFID tag.

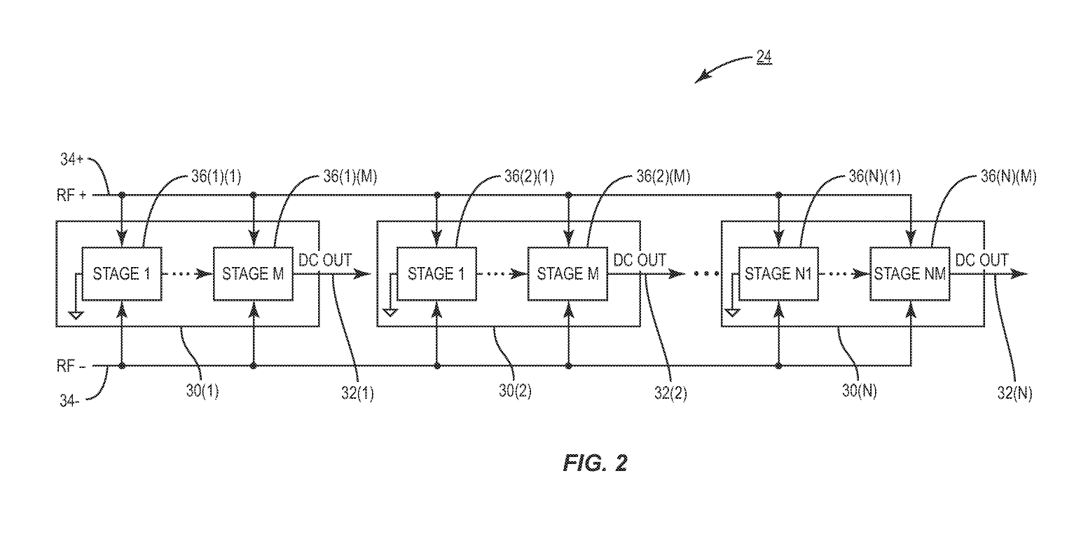

In this regard, FIG. 2 illustrates an exemplary rectifier 24 according to a non-limiting example of the present disclosure. The rectifier 24 includes a first charge pump stage 30(1) having a first power output 32(1) and a second charge pump stage 30(2) having a second power output 32(2). Additional charge pump stages 30 (up to 30(N)) having corresponding power outputs 32 (up to 32(N)) may also be provided. Each of the power outputs 32(1)-32(N) is electrically parallel to the other power outputs 32 in the rectifier 24. Each of the charge pump stages 30 receives at least a portion of the RF input energy from the antenna port 20 through differential RF connections 34+ and 34− (sometimes referred to as RF+ and RF− respectively).

With continuing reference to FIG. 2, the power outputs 32(1)-32(N) provide power to the different partitions of the RFID tag 10. Since most RFID tags 10 have three partitions, there will be three charge pump stages 30(1-3) and corresponding power outputs 32(1-3). However, if desired, more charge pump stages 30 may be used. For example, if a power storage partition is present, then four charge pump stages 30(1-4) may be present. Likewise, if the partitions are divided by other than analog/digital/memory criteria (e.g., by power level requirements), then a different number of partitions may be provided.

With continuing reference to FIG. 2, each charge pump stage 30(1-N) may include one or more sub-stages 36 arranged in series. The sub-stages are denoted herein as 36(1-N)(1-M), where (1-N) denotes the charge pump stage 30 and (1-M) denotes the position of the respective sub-stage 36. Thus, 36(1)(3) represents the third sub-stage 36 within the first charge pump stage 30(1). As noted, the sub-stages 36 within a particular charge pump stage 30 are arranged in series. For example, the output of a first sub-stage 36(1)(1) is serially arranged with an input of a second sub-stage 36(1)(2) (not illustrated) and so on to the last sub-stage 36(1)(M), which provides the power output 32(1). The parallel electrical outputs 32(1), 32(2) allow for a more efficient use of the input energy in terms of current draw and improves voltage droop, thus improving the range and operation of the RFID tag 10.

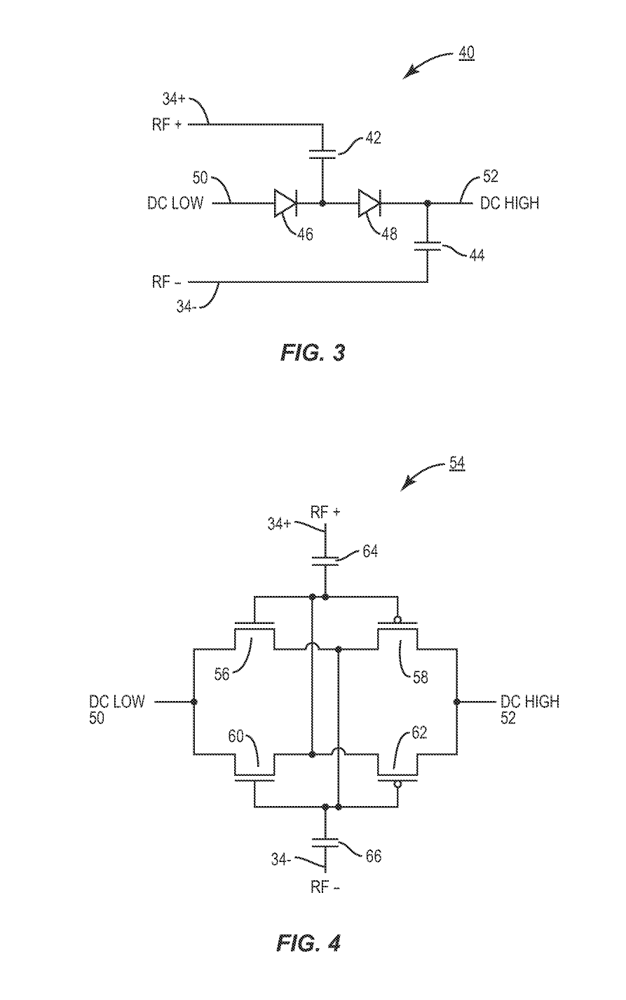

To provide an example of a charge pump stage 36 that can be provided in the rectifier 24, in FIG. 2, FIG. 3 is provided. FIG. 3 illustrates an exemplary conventional charge pump structure 40 that may, in an exemplary embodiment form a sub-stage 36. The structure 40 receives the differential RF signal through the differential RF connections 34+ and 34− and includes two capacitors 42, 44 and two diodes 46, 48. The diodes 46, 48 may be Schottky-barrier diodes. Input power comes through DC LOW line 50 and an output is provided at DC HIGH line 52. If the structure 40 is the final sub-stage 36 within a charge pump stage 30, then the DC HIGH line 52 is the power output 32.

To provide another example alternate exemplary conventional charge pump structure 54 that can be provided the rectifier 24, FIG. 4 is provided. FIG. 4 illustrates an alternate exemplary conventional charge pump structure 54 using field effect transistors (FETs) to achieve a similar result, and that may, in an exemplary embodiment form a sub-stage 36. The structure 54 includes four FETs 56, 58, 60 and 62 and two capacitors 64, 66. In an exemplary embodiment, the FETs 56, 58, 60, and 62 are CMOS FETs. The biasing is such that the FETs are made to turn on at a lower voltage than a practical semiconductor diode, but there comes a point where the devices conduct when current should be blocked, creating an apparent reverse leakage. The voltage drop likewise rises as the square root of the supplied current, versus logarithmically as with the diode topology 40 of FIG. 3, and the implied higher source impedance is a cause of loss that a designer strives to mitigate to realize other advantages of the FET-based approach. The structure 54 receives the differential RF signal through the RF differential connections 34+ and 34−. Likewise, input power comes through DC LOW line 50 and an output is provided at DC HIGH line 52. If the structure 54 is the final sub-stage 36 within a charge pump stage 30, then the DC HIGH line 52 is the power output 32.

Note that the diodes 46, 48 and the FETs 56, 58, 60, and 62 are all defined herein to be rectification devices. Other arrangements of rectification devices or similar elements may be used to create alternate charge pump structures as desired.

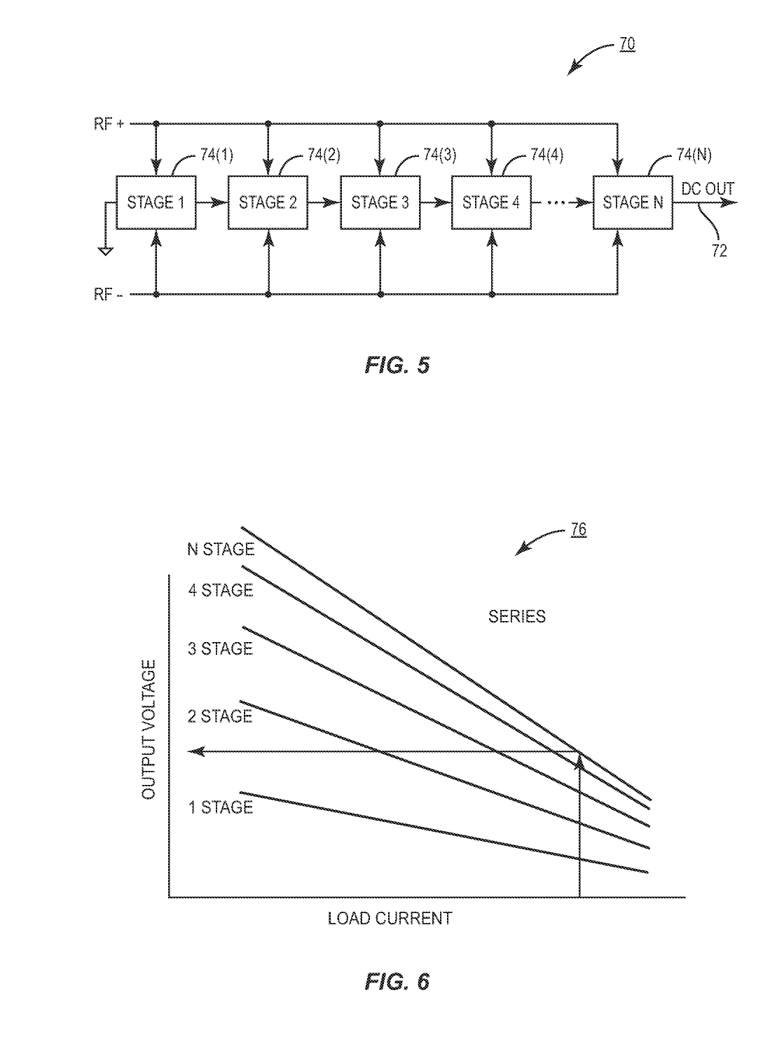

In contrast to the electrically parallel power outputs of the rectifier 24 in FIG. 2, FIG. 5 is provided that illustrates conventional rectifiers 70. The conventional rectifiers 70 provide a single power output 72 from one or more serially connected charge pump stages 74(1-N). That is, the single power output 72 would provide power to the analog partition, the digital partition, and the memory partition of an RFID tag. The combination of partitions puts a substantial load on the rectifier 70. Thus, when rectifiers of this sort are designed, additional charge pump stages 74 are added to increase the voltage supplied. However, as the voltage goes up, the current that can be supplied drops by no less than the same factor. Also of note, the incremental voltage added by each charge pump stage 74 becomes smaller as each charge pump stage 74 is added, due to the bias conditions of each charge pump stage 74.

FIG. 6 is a graph 76 illustrating how the voltage increases with each added stage for the conventional rectifier 70 in FIG. 5, but how the load current drops with increased voltage. The graph 76 highlights the diminishing increased voltage as additional stages 72 are added. The graph 76 or variants may also be used by designers to determine what a particular voltage/current level will be for a given number of stages 72. Any RFID tag requires a minimum current to operate, and it becomes a design consideration to have the rectifier supply this minimum current at the minimum required voltage. If the incident RF signal 22 is not strong enough to meet the minimum voltages and currents, then the tag is non-operational. The strength of the RF signal 22 depends on the distance traveled from the interrogation source, and thus, the more efficient design of rectifier 24 allows for greater range.

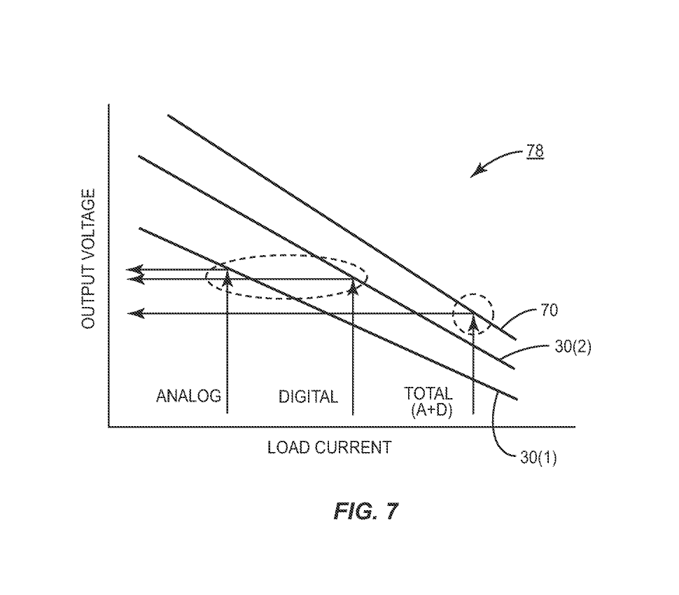

Rectifier 24 provides greater efficiencies by providing the plurality of power outputs 32(1-N) in parallel. This arrangement works because it reduces the load on each output 32. That is, instead of all the voltage and current being produced at a single output 72 and that output 72 having to supply current to each partition, rectifier 24 provides a separate power output 32 for each partition 14, 16, and 18 (as well as any others that may exist). The greater efficiency of rectifier 24 is illustrated by graph 78 presented in FIG. 7. In an exemplary and non-limiting embodiment, the first charge pump stage 30(1) provides power for the analog partition 14 and the second charge pump stage 30(2) provides power for the digital portion. Each requires a certain amount of current, which summed (A+D) is equal to the corresponding current that would be present in a series arranged rectifier 70. However, the individual voltages available from charge pump stages 30(1) and 30(2) are higher and hence, more efficient. Note that the impedance to the RF input (i.e., the antenna port 20) is largely unchanged, as the inputs to all sub-stages 36 appear in parallel to the antenna 12, just as the stages 74 appear in parallel in rectifier 70. In short, the parallel outputs 32(1-N) make for a more efficient rectifier 24 and allow greater range in the operation of an RFID tag 10.

Note that within a charge pump stage 30, a plurality of sub-stages 36 may be arranged in series to achieve a desired operating voltage. However, as noted, because the load on a given charge pump stage 30 is less than on the rectifier 70, the efficiencies of the present disclosure are achieved.

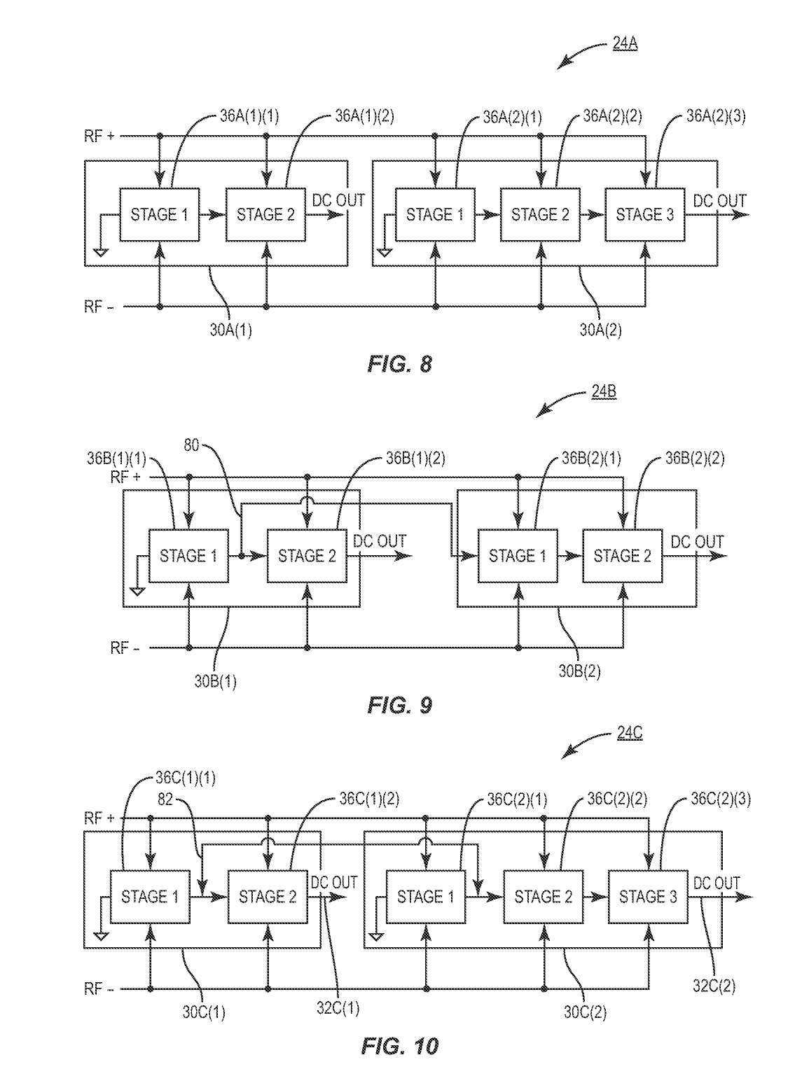

Further note that the charge pump stages 30 do not have to be uniform. For example, a first charge pump stage 30A(1) of rectifier 24A illustrated in FIG. 8 may have two sub-stages 36A(1)(1) and 36A(1)(2) while a second charge pump stage 30A(2) may have three sub-stages 36A(2)(1), 36A(2)(2), and 36A(2)(3). This sort of arrangement may be appropriate if the loads for the respective partitions differ. For example, the analog partition 14 may have a lower load and only need the voltage available from the two sub-stages 36A(1)(1) and 36A(1)(2) while the digital partition 16 may have a comparatively higher load and require the voltage available from three sub-stages 36A(2)(1), 36A(2)(2), and 36A(2)(3).

An alternate embodiment of a parallel-stage power output rectifier, rectifier 24B, is illustrated in FIG. 9. The rectifier 24B in FIG. 9 is an alternate embodiment where the sub-stages 36 are varied to achieve different voltage and current capabilities depending on load requirements. In particular, a first charge pump stage 30B(1) has an intermediate output tap 80 positioned between two of the sub-stages 36 (in this case between 36B(1)(1) and 36B(1)(2)). The intermediate output tap 80 is electrically coupled to the second charge pump stage 30B(2). The use of a common initial sub-stage 36 (i.e., 36B(1)(1) serves as a common first sub-stage for both the charge pump stage 30B(1) and 30B(2)) may allow for reduced circuitry. As illustrated, the intermediate output tap 80 is electrically coupled to an initial or first sub-stage 36B(2)(1) in the second charge pump stage 30B(2).

In contrast to the intermediate output tap 80 being electrically coupled to the initial or first sub-stage 36B(2)(1) in FIG. 9, the intermediate output tap may be electrically coupled to an intermediate position between two sub-stages 36 of a second or later charge pump stage 30. An exemplary embodiment of such an alternate rectifier 24C is presented in FIG. 10. In this exemplary embodiment, the intermediate output tap 82 is positioned between two of the sub-stages 36 (in this case between 36C(1)(1) and 36C(1)(2)) of the first charge pump stage 30C(1) and electrically coupled to a position between two sub-stages 36 of the second charge pump stage 30C(2) (in this case between 36C(2)(1) and 36C(2)(2)). The rectifier 24C effectively allows for averaging the demand of the two outputs 32C(1) and 32C(2). Other arbitrary series-parallel arrangements are also possible so as to optimize the supply requirements of the respective partitions.

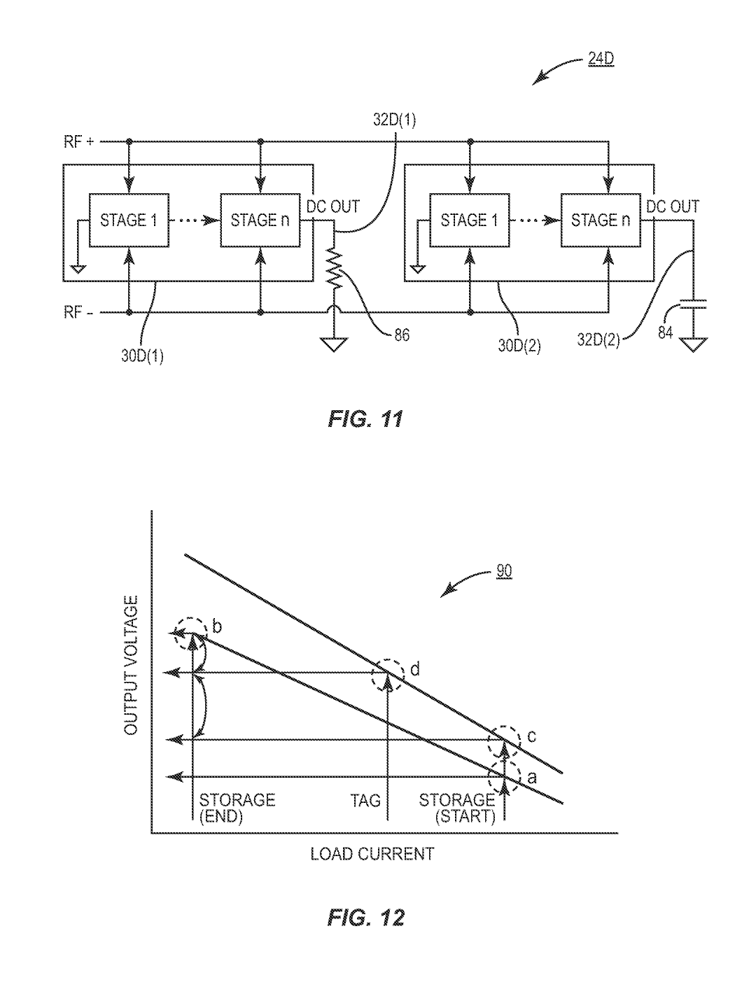

As another alternate embodiment, a rectifier 24D illustrated in FIG. 11 allows for variations in power delivery across time as well as space. Rectifier 24D includes a capacitor 84 that stores energy for reuse. Exemplary uses of this stored energy include, but are not limited to flashing an LED (not illustrated), powering a temperature or environmental sensor or other external device, or otherwise operating elements of a partition 14, 16, or 18 when power is otherwise not available. Capacitor 84 is representative of a dynamic power demand as opposed to a static power demand represented by a resistor 86. When the capacitor 84 is uncharged, it places an extra demand on the current supplied by the rectifier 24D, whereas once the capacitor 84 reaches its charged condition, current falls as the capacitor 84 reaches the maximum voltage the rectifier 24D can deliver. The operating point transits a load line from point from point “a” to point “b”, as illustrated in graph 90 of FIG. 12 during this charging event. Without separation of the charge pump stages 30D, the capacitor 84 places an undue burden on the rectifier output when uncharged, limiting voltage available to the static load 86 (point “c”). Conversely, once the capacitor 84 reaches the largest voltage that can be supplied to the static load 86, higher voltages are unobtainable (point “d”). Therefore providing the parallel arrangement of rectifier 24D enables both static and dynamic circuits to provide a higher output voltage for the operating conditions by an amount (V_{b}-V_{d}) for the capacitor 84 and (V_{d}-V_{c}) for the resistor 86.

Instead of a literal capacitor 84, the capacitor 84 of FIG. 11 may represent a power storage partition. Such power storage partition may be embedded in a previously existing partition 14, 16, or 18 or a separate partition (whether external to the RFID tag 10 or internal to the RFID tag 10) as desired. Thus, as used herein, a partition may include such dynamic elements. To the extent that such dynamic elements may be present in digital or analog partitions, references to such analog or digital partitions may also include such dynamic elements.

Note also, that in certain designs, the designer may use one or more analog partitions, one or more digital partitions, one or more memory partitions and/or one or more power storage partitions. Each such partition may have power provided by a respective charge pump stage using an appropriate number of sub-stages. Such variations are contemplated and within the scope of the present disclosure.

It should be appreciated that the embodiments disclosed above are useful in the unlicensed UHF bands (902-928 MHz in the United States) as non-limiting frequencies. Higher frequencies (e.g., greater than 1 GHz) may also be used by the above disclosed embodiments without limitation. Higher frequencies introduce stray parasitic inductances and capacitances. Furthermore, propagation delays through active devices (e.g., transistors and diodes) may also impact performance.

In this regard, one additional and optional approach associated with higher frequencies may be conversion of higher frequencies to lower frequencies prior to rectification. To preserve the energy budget for an RFID tag, for example, a design may include providing near lossless downconversion. This downconversion is not limited to the RFID context and may be used, for example, in radiometry and remote sensing circuits and related applications. One approach would be an RF-powered cross-coupled oscillator in which the RF carrier is injected across what would otherwise be the power supply nodes, with steady-state oscillation at a resonant frequency that is a sub-multiple of the carrier. This arrangement effectively downconverts the incident energy to a lower frequency, where rectification of the incident energy can be performed with lower loss. A net increase in overall efficiency can be achieved.

As an example, a non-limiting downcoversion factor of two can be used. Downconversion ratios of 4:1 or even 10:1 are possible. Thus, for example, rectification can be performed at frequencies of, for example, 100 MHz to 400 MHz, where parasitic losses in the transistors can be significantly lower using conventional fabrication techniques. Similarly, carrier frequencies, such as 12 GHz, can be employed, showing a frequency capability more than an order of magnitude higher than current passive RFID systems. This flexibility can allow for operation in unlicensed ISM bands such as 2.45 GHz and 5.6 GHz, as non-limiting examples.

Many modifications and other embodiments of the embodiments set forth herein will come to mind to one skilled in the art to which the embodiments pertain having the benefit of the teachings presented in the foregoing descriptions and the associated drawings. For example, the antenna arrangements may include any type of antenna desired, including but not limited to dipole, monopole, and slot antennas. The distributed antenna systems that employ the antenna arrangements disclosed herein could include any type or number of communications mediums, including but not limited to electrical conductors, optical fiber, and air (i.e., wireless transmission).

Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

We claim:

1. A radio-frequency identification (RFID) tag, comprising a partition, the partition comprising:
an input configured to connect to a radio-frequency (RF) antenna to receive an RF signal comprising RF input energy; and
a rectifier configured to split the RF input energy, the rectifier comprising:
a first charge pump stage configured to receive at least a portion of the RF input energy from the input and provide a first power output; and
a second charge pump stage configured to receive at least a portion of the RF input energy from the input and provide a second power output electrically parallel to the first power output.

2. The RFID tag of claim 1, wherein the partition comprises an analog partition and the first power output is configured to provide power to the analog partition.

3. The RFID tag of claim 2, further comprising a second partition distinct from the analog partition and the second power output is configured to provide power to the second partition.

4. The RFID tag of claim 3, wherein the second partition is selected from the group consisting of: a digital partition, a memory partition, and a power storage partition.

5. The RFID tag of claim 1, wherein the first charge pump stage comprises a plurality of sub-stages arranged in series.

6. The RFID tag of claim 1, wherein the first charge pump stage comprises at least one rectification device.

7. The RFID tag of claim 1, wherein the rectifier further comprises a third charge pump stage configured to provide a third power output.

8. The RFID tag of claim 7, further comprising a second partition and a third partition, and
wherein the first power output is configured to provide power to the partition, the second power output is configured to provide power to the second partition, and the third power output is configured to provide power to the third partition.

9. The RFID tag of claim 5, wherein the first charge pump stage further comprises an intermediate output tap positioned between two of the plurality of sub-stages, and wherein the intermediate output tap is electrically coupled to the second charge pump stage.

10. The RFID tag of claim 9, wherein the intermediate output tap is electrically coupled to an initial sub-stage of the second charge pump stage.

11. The RFID tag of claim 9, wherein the intermediate output tap is electrically coupled to an intermediate position between two sub-stages of the second charge pump stage.

12. A radio-frequency identification (RFID) rectifier configured to split input radio-frequency (RF) energy into multiple power stages, comprising:
a first charge pump stage configured to receive RF input energy from an antenna and provide a first power output; and
a second charge pump stage configured to receive the RF input energy from the antenna and provide a second power output electrically parallel to the first power output.

13. The RFID rectifier of claim 12, wherein the first charge pump stage comprises a plurality of sub-stages arranged in series.

14. The RFID rectifier of claim 13, wherein each of the plurality of sub-stages comprises a plurality of rectification devices.

15. The RFID rectifier of claim 14, wherein each of the plurality of rectification devices comprises an element selected from the group consisting of: diodes and field effect transistors.

16. The RFID rectifier of claim 13, wherein the first charge pump stage further comprises an intermediate output tap positioned between two of the plurality of sub-stages, and wherein the intermediate output tap is electrically coupled to the second charge pump stage.

17. The RFID rectifier of claim 12, further comprising a third charge pump stage configured to provide a third power output.

18. A method for splitting input radio-frequency (RF) energy into multiple power stages, comprising:
receiving at a first charge pump stage in a rectifier RF input energy from an antenna;
providing a first power output from the first charge pump stage;
receiving at a second charge pump stage in the rectifier RF input energy from the antenna; and
providing a second power output from the second charge pump stage, wherein the second power output is electrically parallel to the first power output.

19. The method of claim 18, further comprising providing power from the first power output to a first partition and providing power from the second power output to a second partition.

20. The method of claim 19, wherein providing power to the first partition comprises providing power to an analog partition and providing power to the second partition comprises providing power to a partition selected from the group consisting of: digital, memory, and power storage partitions.

21. The method of claim 18, wherein receiving at the first charge pump stage comprises receiving at a first charge pump stage formed from a plurality of rectification devices.

22. The method of claim 18, further comprising providing an intermediate output tap from the first charge pump stage to the second charge pump stage.

23. A radio-frequency identification (RFID) tag comprising:
an input configured to connect to a radio-frequency (RF) antenna to receive an RF signal comprising RF input energy;
a rectifier configured to split the RF input energy, the rectifier comprising:
a first charge pump stage configured to receive at least a portion of the RF input energy from the input and provide a first power output; and
a second charge pump stage configured to receive at least a portion of the RF input energy from the input and provide a second power output electrically parallel to the first power output;
a static load coupled to the first power output; and
a dynamic load coupled to the second power output, wherein the dynamic load is configured to store power for later use.
